(19) United States
(12) Patent Application Publication
(10) Pub. No.: US 2018/0163828 A1
(43) Pub. Date: Jun. 14, 2018

(54) PRINTER GEAR ARRANGEMENT

(71) Applicant: HEWLETT-PACKARD DEVELOPMENT COMPANY, L.P., Houston, TX (US)

(72) Inventors: Steve A. O'Hara, 1115 SE 164th Ave, Columbia Center, Suit, WA (US); Luke P. Sosnowski, Vancouver, WA (US); Scott Martin, Vancouver, WA (US)

(73) Assignee: HEWLETT-PACKARD DEVELOPMENT COMPANY, L.P., Houston, TX (US)

(21) Appl. No.: 15/571,005

(22) PCT Filed: Jul. 31, 2015
(86) PCT No.: PCT/US2015/043286

§ 371 Date: Oct. 31, 2017

(51) Int. Cl. F16H 19/04; B41J 2/165; B41J 2/175; B41J 29/00

(52) U.S. Cl. CPC F16H 19/04; B41J 29/00; B41J 2/175; B41J 2/16547

(57) ABSTRACT

A gear arrangement for a printer includes a rack and a pinion. The rack has a first end, a first tooth at the first end, and a second tooth adjacent the first tooth, with a width of the first tooth being greater than a width of the second tooth, and the pinion has a first tooth, a second tooth adjacent the first tooth, and a web between the first tooth and the second tooth, with the web to prevent engagement of the first tooth of the rack between the first tooth and the second tooth of the pinion.

### BACKGROUND

A printer, including, for example, an inkjet print, a laser printer, a 3-D printer, or other type of printer, may include a printhead and a service station to service or maintain functionality of the printhead. Operation of the service station may include relative motion between the service station and the printhead.

### BRIEF DESCRIPTION OF THE DRAWINGS

FIG. 1 is a block diagram illustrating one example of a printing system.

FIG. 2 is a schematic illustration of one example of a service station assembly for a printing system.

FIG. 3 is a bottom perspective view illustrating one example of a portion of a service station assembly for a printing system including one example of a rack-and-pinion gear arrangement.

FIG. 4 is a bottom perspective view illustrating one example of the rack of FIG. 3.

FIGS. 5A, 5B, 5C and 5D illustrate one example of the pinion of FIG. 3.

FIG. 6 is an enlarged view of a portion of the rack-and-pinion gear arrangement within the dashed area of the example of FIG. 3.

FIG. 7 illustrates one example of engagement of the rack-and-pinion gear arrangement of FIG. 3.

FIG. 8 illustrates one example of further engagement of the rack-and-pinion gear arrangement of FIG. 3.

FIG. 9 illustrates one example of blocked engagement of the rack-and-pinion gear arrangement of FIG. 3.

FIG. 10 is a flow diagram illustrating one example of a method of engagement of a rack-and-pinion gear arrangement for a printing system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

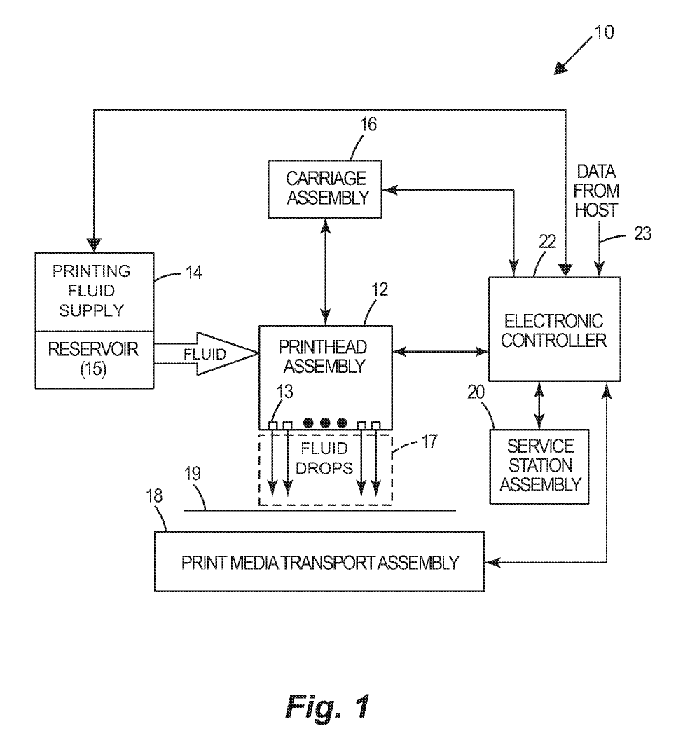

FIG. 1 illustrates one example of a printing system 10. In one example, printing system 10 is an inkjet printing system and includes a fluid ejection assembly, such as printhead assembly 12, and a fluid supply assembly, such as printing fluid supply 14. In the illustrated example, printing system 10 also includes a carriage assembly 16, a print media transport assembly 18, a service station assembly 20, and an electronic controller 22.

Printhead assembly 12 includes at least one printhead or fluid ejection device which ejects drops of printing fluid or other fluid through a plurality of orifices or nozzles 13. In one example, the drops are directed toward a medium, such as print media 19, so as to print onto print media 19. Print media 19 includes, for example, any type of suitable sheet material, such as paper, card stock, transparencies, Mylar, fabric, and the like, packaging material, or other printable material. In one example, nozzles 13 are arranged in at least one column or array such that properly sequenced ejection of printing fluid from nozzles 13 causes characters, symbols, and/or other graphics or images to be printed upon print media 19 as printhead assembly 12 and print media 19 are moved relative to each other.

Printing fluid supply 14 supplies printing fluid to printhead assembly 12 and includes a reservoir 15 for storing printing fluid. As such, in one example, printing fluid flows from reservoir 15 to printhead assembly 12. In one example, printhead assembly 12 and printing fluid supply 14 are housed together in an inkjet or fluid-jet print cartridge or pen. In another example, printing fluid supply 14 is separate from printhead assembly 12 and supplies printing fluid to printhead assembly 12 through an interface connection, such as a supply tube.

Carriage assembly 16 positions printhead assembly 12 relative to print media transport assembly 18 and print media transport assembly 18 positions print media 19 relative to printhead assembly 12. Thus, a print zone 17 is defined adjacent to nozzles 13 in an area between printhead assembly 12 and print media 19. In one example, printhead assembly 12 is a scanning type printhead assembly such that carriage assembly 16 moves printhead assembly 12 relative to print media transport assembly 18. In another example, printhead assembly 12 is a non-scanning type printhead assembly such that carriage assembly 16 fixes printhead assembly 12 at a prescribed position relative to print media transport assembly 18. Print media transport assembly 18 may include, for example, a variety of guides, rollers, wheels, etc. for the handling and/or routing of print media 19 through printing system 10, including transporting, guiding, and/or directing print media 19 to print zone 17, and/or transporting, guiding, and/or directing print media 19 away from print zone 17.

Service station assembly 20 provides for spitting, wiping, capping, and/or priming of printhead assembly 12 in order to maintain a functionality of printhead assembly 12 and, more specifically, nozzles 13. For example, service station assembly 20 may include a rubber blade or wiper which is periodically passed over printhead assembly 12 to wipe and clean nozzles 13 of excess printing fluid. In addition, service station assembly 20 may include a cap which covers printhead assembly 12 to protect nozzles 13 from drying out during periods of non-use. In addition, service station assembly 20 may include a spittoon into which printhead assembly 12 ejects printing fluid to insure that reservoir 15 maintains an appropriate level of pressure and fluidity, and insure that nozzles 13 do not clog or weep. Functions of service station assembly 20 may include relative motion between service station assembly 20 and printhead assembly 12.

Electronic controller 22 communicates with printhead assembly 12, carriage assembly 16, print media transport assembly 18, and service station assembly 20. Thus, in one example, when printhead assembly 12 is mounted in carriage assembly 16, electronic controller 22 and printhead assembly 12 communicate via carriage assembly 16. Electronic controller 22 also communicates with printing fluid supply 14 such that, in one implementation, a new (or used) printing fluid supply may be detected, and a level of printing fluid in the printing fluid supply may be detected.

Electronic controller 22 receives data 23 from a host system, such as a computer, and may include memory for temporarily storing data 23. Data 23 may be sent to printing system 10 along an electronic, infrared, optical or other information transfer path. Data 23 represents, for example, a document and/or file to be printed. As such, data 23 forms a print job for printing system 10 and includes print job commands and/or command parameters.

In one example, electronic controller 22 provides control of printhead assembly 12 including timing control for ejection of printing fluid drops from nozzles 13. As such, electronic controller 22 defines a pattern of ejected printing fluid drops which form characters, symbols, and/or other graphics or images on print media 19. Timing control and, therefore, the pattern of ejected printing fluid drops, is determined by the print job commands and/or command parameters. In one example, logic and drive circuitry forming a portion of electronic controller 22 is located on printhead assembly 12. In another example, logic and drive circuitry forming a portion of electronic controller 22 is located off printhead assembly 12.

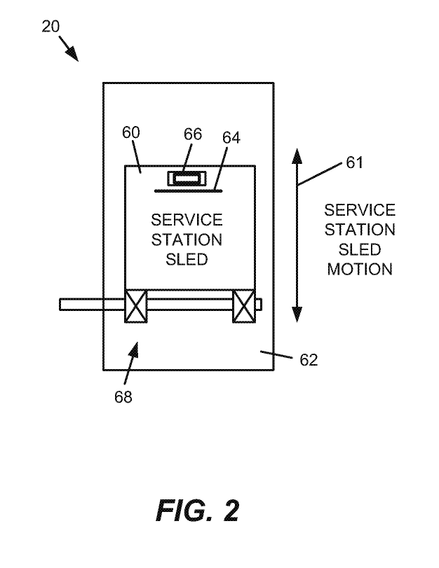

In one example, as schematically illustrated in FIG. 2, service station assembly 20 includes a service station pallet or sled 60 and a frame or chassis 62. In one implementation, service station sled 60 supports at least one wiper 64 which passes over printhead assembly 12 to clean and/or remove debris or fluid from a face of printhead assembly 12. In one implementation, service station sled 60 supports at least one cap 66 which covers printhead assembly 12 when not in use to prevent printhead assembly 12 from drying out. Wiping and capping of printhead assembly 12 can utilize motion of service station assembly 20 and, more specifically, motion of service station sled 60 relative to printhead assembly 12. As such, in one implementation, service station assembly 20 includes a gear arrangement 68 for motion of service station sled 60 such that service station sled 60 is mounted in chassis 62 for movement, as indicated by bi-directional arrow 61.

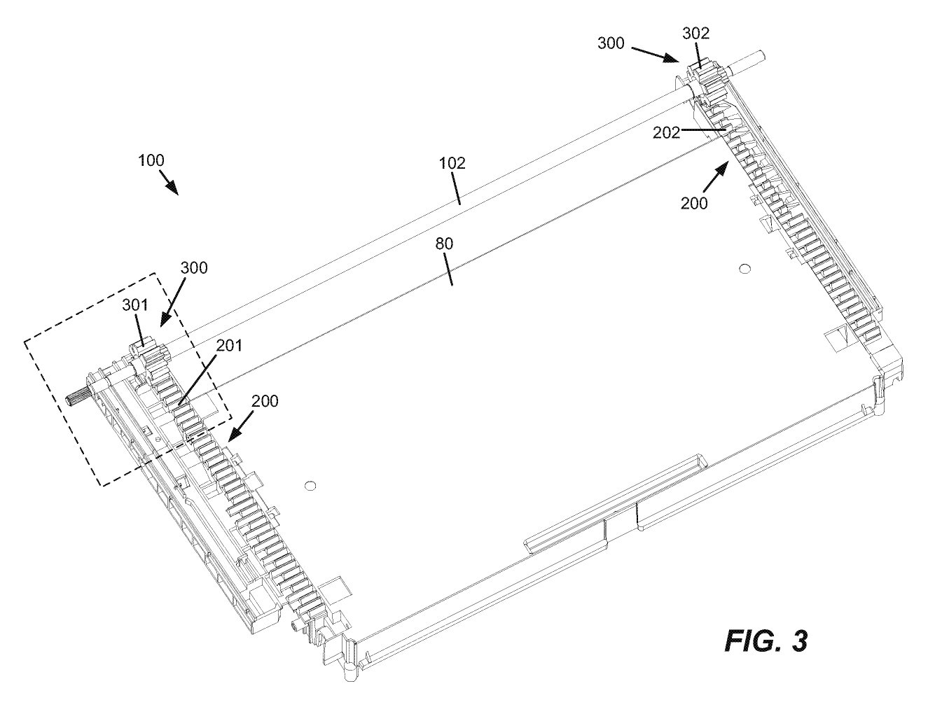

FIG. 3 is a bottom perspective view illustrating one example of a portion of a service station assembly, such as service station assembly 20, including a service station sled 80, as an example of service station sled 60, and a rack-and-pinion gear arrangement 100, as an example of gear arrangement 68, for movement or motion of sled 80 in servicing of printhead assembly 12, as described above.

In one example, gear arrangement 100 includes a rack 200 supported by or formed with sled 80, and a pinion 300 to engage rack 200. In one implementation, gear arrangement 100 includes two racks 201 and 202, one positioned toward each side of sled 80, and two pinions 301 and 302, each to engage a corresponding one of the racks 201 and 202. In one example, a drive shaft 102 extends between pinions 301 and 302 to rotate pinions 301 and 302 and move sled 80.

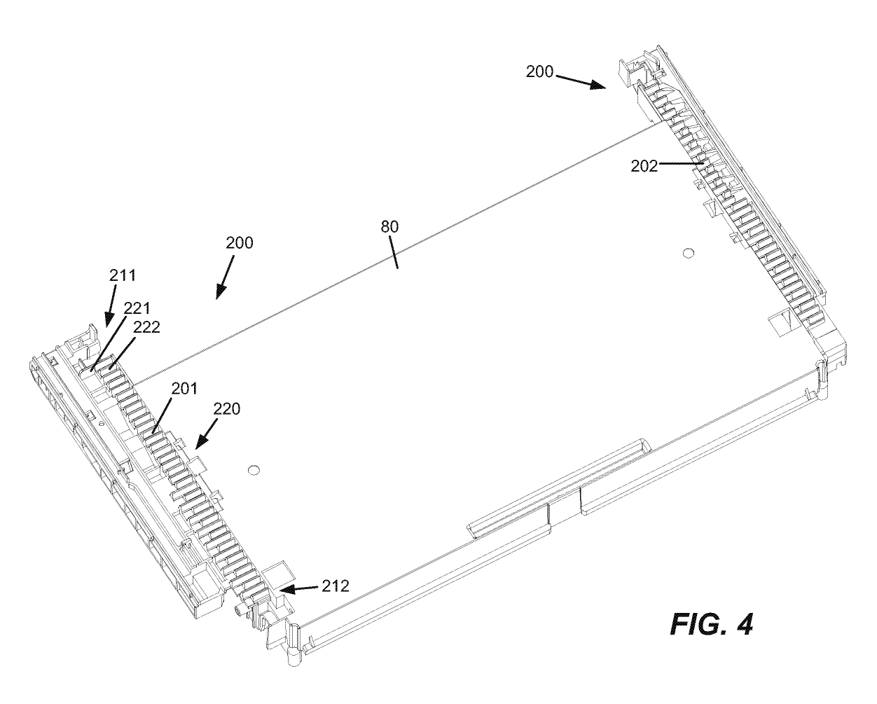

FIG. 4 is a bottom perspective view illustrating one example of rack 200 as supported by or formed with sled 80. In one example, rack 200, including rack 201 and rack 202, has a first end 211 and a second opposite end 212. In one implementation, first end 211 represents an end to be engaged with pinion 300 when sled 80 is inserted or installed in printing system 10. In one example, rack 200 includes a series of teeth 220 with a first tooth 221 being an initial of or first tooth in the series and a second tooth 222 being a next or second tooth in the series. In one implementation, first tooth 221 forms an indexing tooth for initial engagement between rack 200 and pinion 300, as described below.

In one example, a width of first tooth 221 is greater than a width of second tooth 222. As such, first tooth 221 and second tooth 222 form a series or sequence of alternating width teeth including, more specifically, a wide tooth followed by a narrow tooth. In some examples, rack 200 has one series or more than one series of alternating width teeth.

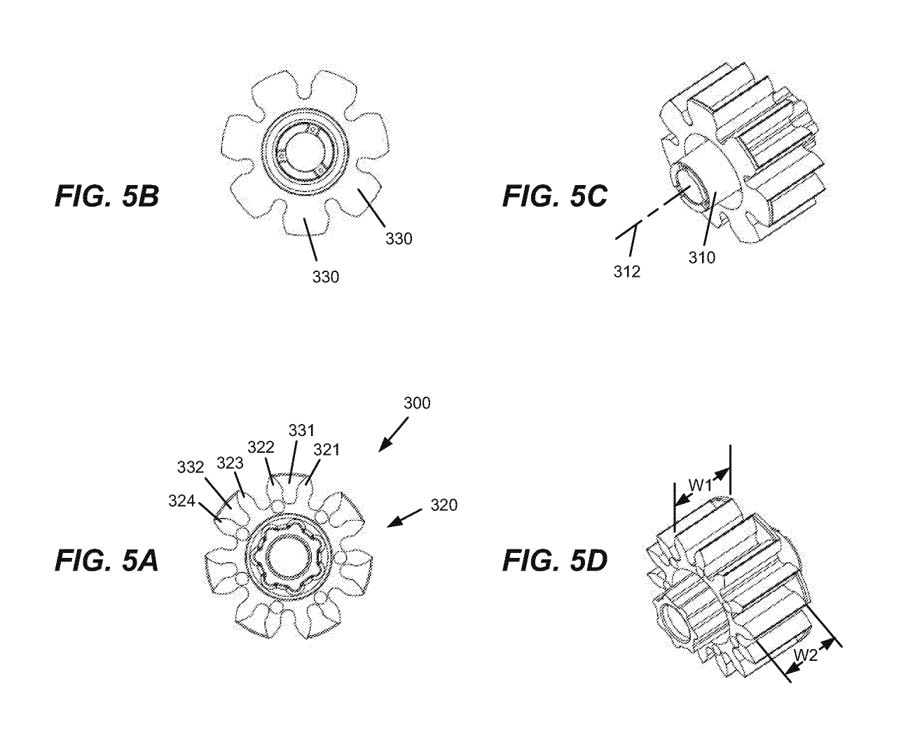

FIGS. 5A, 5B, 5C and 5D illustrate one example of pinion 300. In one example, pinion 300, including pinion 301 and pinion 302, includes a central hub 310 with an axis of rotation 312, and a plurality of teeth 320 extending from hub 310. In one example, a web 330 extends between or joins adjacent teeth 320 including, more specifically, a pair of adjacent teeth 320. Web 330 includes or forms a connecting element between a pair of adjacent teeth 320 and, as described below, partially blocks or fills a space between the pair of adjacent teeth 320 so as to limit or control engagement between the pair of adjacent teeth 320. More specifically, web 330 limits the width of a tooth to be engaged with pinion 300 between the pair of adjacent teeth 320.

In one example, web 330 is formed with and extends between or joins the ends or sides of a pair of adjacent teeth 320. More specifically, in one implementation, web 330 extends between or joins the tips of a pair of adjacent teeth 320 and extends between or joins opposing faces of a pair of adjacent teeth 320. As such, web 330 partially blocks or fills a space between the pair of adjacent teeth 320 at an end or side of the pair of adjacent teeth 320.

In one example, pinion includes a plurality of webs 330, with each web 330 extended between or joining alternating pairs of adjacent teeth 320. For example, in one implementation, teeth 321 and 322 form one pair of adjacent teeth 320, and teeth 323 and 324 form another pair of adjacent teeth 320. As such, web 331, as one example of web 330, extends between or joins adjacent teeth 321 and 322, and web 332, as another example of web 330, extends between or joins adjacent teeth 323 and 324. Web 330, however, does not extend between or join adjacent teeth 322 and 323. Thus, inclusion of web 330 alternates between pairs of adjacent teeth 320.

In one example, teeth 320 each have a full tooth width W1 such that web 330 is provided at an end of width W1. As such, web 330 partially blocks or fills a space between the respective pair of adjacent teeth 320, thereby resulting in a reduced face width W2 of opposing faces of the respective pair of adjacent teeth 320. As such, in one implementation, each tooth of the pair of adjacent teeth 320 includes a first face having a width corresponding to the full tooth width W1, and a second face having reduced face width W2. Thus, as described below, teeth 220 of rack 200 which have a width less than reduced face width W2 may engage the space between the pair of adjacent teeth 320 joined by web 330. For example, only teeth 220 of rack 200 which have a width less than reduced face width W2 may engage the space between teeth 321 and 322, and the space between teeth 323 and 324.

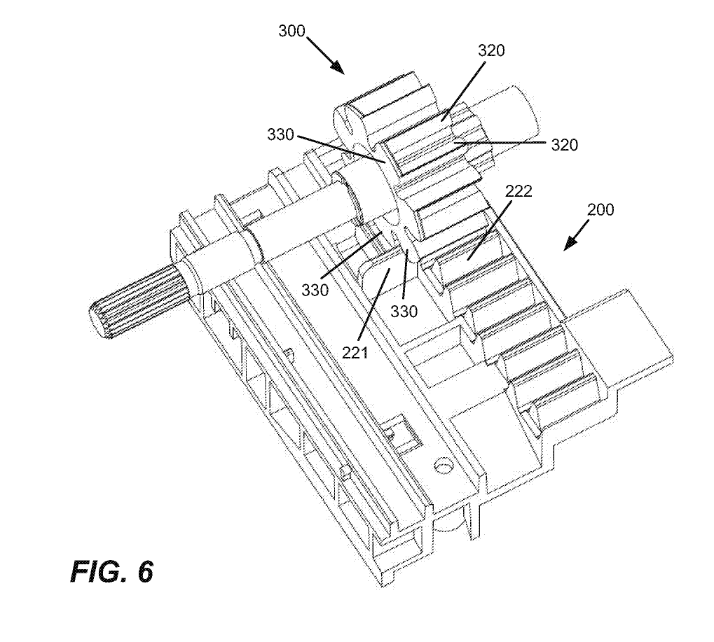

FIG. 6 is an enlarged view of a portion of gear arrangement 100 within the dashed area of the example of FIG. 3, including one example of engagement of rack 200 and pinion 300. As illustrated in the example of FIG. 6, rack 200 is engaged with pinion 300 such that first tooth 221 engages pinion 300 between one tooth of a first pair of adjacent teeth 320 having web 330 therebetween and one tooth of a second pair of adjacent teeth 320 having web 330 therebetween. Thus, first tooth 221 of rack 200 engages pinion 300 between alternating pairs of adjacent teeth 320 which have web 330 therebetween. More specifically, first tooth 221 of rack 200 engages pinion 300 between teeth 320 which are not joined by web 330.

As illustrated in the example of FIG. 6, and as described above, a width of first tooth 221 of rack 200 is greater than a width of second tooth 222 of rack 200. More specifically, first tooth 221 of rack 200 has a width greater than reduced face width W2 (FIG. 5D) of pinion 300, and second tooth 222 of rack 200 has a width less than reduced face width W2 (FIG. 5D) of pinion 300. As such, first tooth 221 can only engage pinion 300 between teeth 320 which are not joined by web 330, and second tooth 222 can engage pinion 300 between teeth 320 which are joined by web 330. Thus, between teeth 320 which are not joined by web 330, pinion can be engaged by teeth 220 of rack 200 of any width and, between teeth 320 which are joined by web 330, pinion 300 can be engaged only by teeth 220 of rack 200 which have a width less than reduced face width W2 (FIG. 5D). This arrangement helps provide for aligned or correct engagement between rack 200 and pinion 300, as described below.

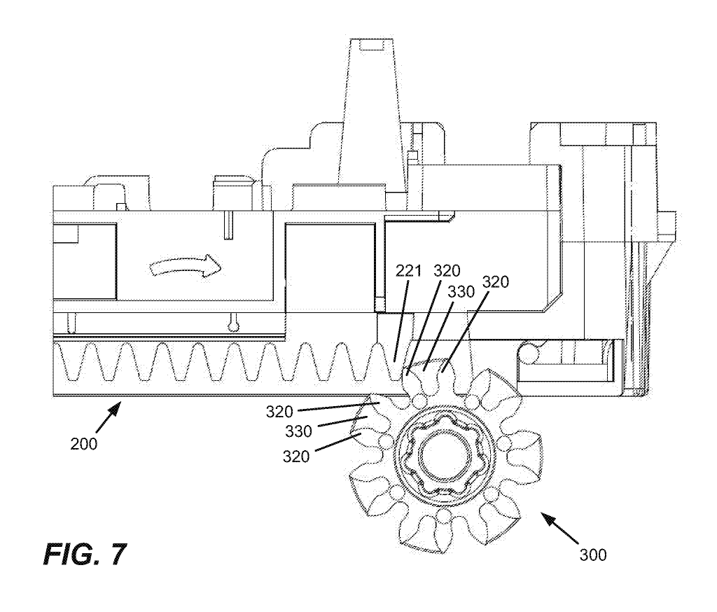

FIG. 7 illustrates one example of engagement of gear arrangement 100, including engagement between rack 200 and pinion 300. As first tooth 221 of rack 200 has a width greater than reduced face width W2 (FIG. 5D), rack 200 is engaged with pinion 300 such that first tooth 221 of rack 200 engages pinion 300 between alternating pairs of adjacent teeth 320 which have web 330 extending therebetween. More specifically, first tooth 221 engages pinion 300 between one tooth of a first pair of adjacent teeth 320 having web 330 therebetween and one tooth of a second pair of adjacent teeth 320 having web 330 therebetween. Thus, first tooth 221 of rack 200 engages pinion 300 between teeth 320 which are not joined by web 330.

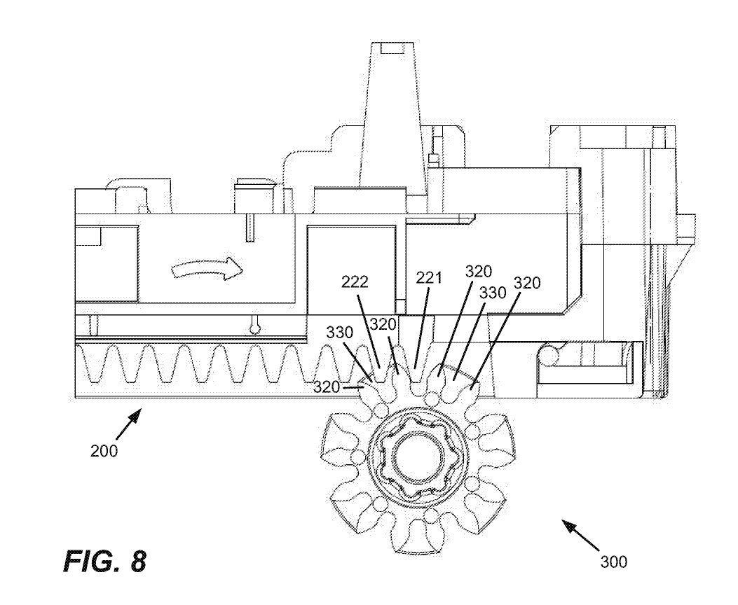

FIG. 8 illustrates one example of further engagement of gear arrangement 100, including further engagement between rack 200 and pinion 300. As second tooth 222 of rack 200 has a width less than reduced face width W2 (FIG. 5D), rack 200 is further engaged with pinion 300 such that first tooth 221 of rack 200 engages pinion 300 between teeth 320 which are not joined by web 330, and second tooth 222 of rack 200 engages pinion 300 between teeth 320 which are joined by web 330. Thus, FIGS. 7 and 8 illustrate one example of proper or correct engagement between rack 200 and pinion 300.

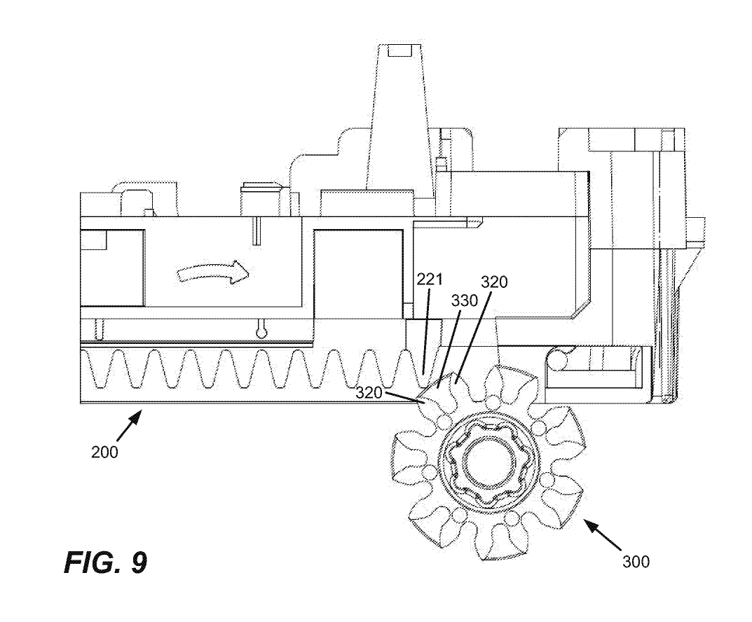

FIG. 9 illustrates one example of blocked engagement of gear arrangement 100, including blocked engagement between rack 200 and pinion 300. More specifically, as first tooth 221 of rack 200 has a width greater than reduced face width W2 (FIG. 5D), first tooth 221 hits or contacts web 330 which joins adjacent teeth 320. As such, engagement of first tooth 221 between adjacent teeth 320 which are joined by web 330 is prevented such that rack 200 is blocked from engagement with pinion 300. Thus, FIG. 9 illustrates one example of blocked engagement between rack 200 and pinion 300, so as to avoid or prevent misaligned or incorrect engagement between rack 200 and pinion 300.

Furthermore, as first tooth 221 hits or contacts web 330, pinion 300 rotates such that tooth 221 engages pinion 300 between teeth 320 which are not joined by web 330, and second tooth 222 of rack 200 engages pinion 300 between teeth 320 which are joined by web 330, as illustrated, for example, in FIGS. 7 and 8. Thus, proper or correct engagement between rack 200 and pinion 300 is achieved.

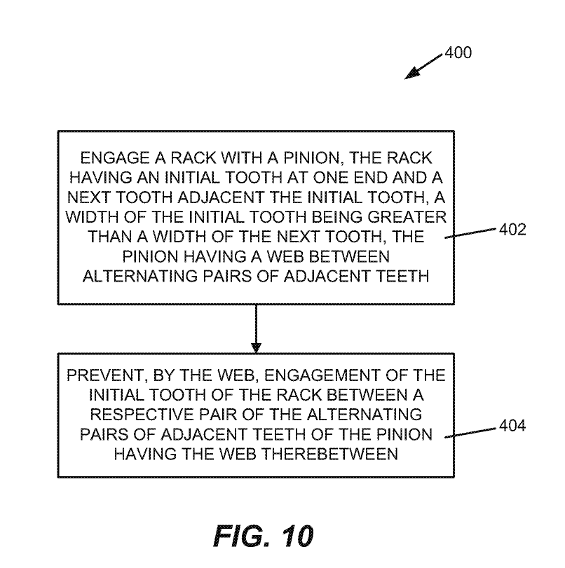

FIG. 10 is a flow diagram illustrating one example of a method 400 of gear engagement, such as engagement of gear arrangement 100, in a printer, such as printing system 10.

With method 400, at 402, a rack, such as rack 200, as illustrated in the example of FIG. 4, is engaged with a pinion, such as pinion 300, as illustrated in the example of FIGS. 5A, 5B, 5C and 5D. In one example, the rack has an initial tooth at one end, such as first tooth 221 at first end 211, as illustrated in the example of FIG. 4, and a next tooth adjacent the initial tooth, such as second tooth 222, as illustrated in the example of FIG. 4. In one example, a width of the initial tooth is greater than a width of the next tooth, as illustrated, for example, in FIGS. 4 and 6. In one example, the pinion, such as pinion 300, as illustrated in the example of FIGS. 5A, 5B, 5C and 5D, has a web, such as web 330, as illustrated in the example of FIGS. 5A, 5B, 5C and 5D, between alternating pairs of adjacent teeth. For example, between adjacent teeth 321 and 322, and between adjacent teeth 323 and 324, as illustrated in the example of FIGS. 5A, 5B, 5C and 5D.

As such, at 404, in engaging the rack with the pinion, the web prevents engagement of the initial tooth of the rack between a respective pair of the alternating pairs of adjacent teeth of the pinion having the web therebetween. For example, web 330 prevents engagement of first tooth 221 between adjacent teeth 320, as illustrated in the example of FIG. 9.

With a gear arrangement as disclosed herein, misaligned or incorrect engagement between the rack and the pinion may be prevented. More specifically, as the web between the adjacent teeth of the pinion reduces the face width of the opposing faces of the adjacent teeth and the first tooth of the rack has a width greater than the reduced face width, the first tooth of the rack is prevented from engagement between the adjacent teeth of the pinion which have the web therebetween when the rack is engaged with the pinion. As the web extends between or joins two adjacent teeth of the pinion, misalignment of the rack and the pinion by a single tooth, which may be difficult to detect, may be avoided, for example, when the service station sled is inserted or installed. Furthermore, as the first tooth of the rack is permitted to engage the pinion between adjacent teeth of the pinion which are not joined by the web, proper or correct engagement between the rack and the pinion may be achieved. Thus, proper or correct alignment or indexing of the rack to the pinion may be established, for example, when the service station sled is inserted or installed. While the gear arrangement disclosed herein is illustrated and described for use in a printer, including, more specifically, for use with a service station sled of a service station of a printer, the gear arrangement disclosed herein may be used with non-printer devices or have other printer or non-printer applications.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A gear arrangement for a printer, comprising:
a rack having a first end, a first tooth at the first end, and a second tooth adjacent the first tooth, a width of the first tooth being greater than a width of the second tooth; and
a pinion having a first tooth, a second tooth adjacent the first tooth, and a web between the first tooth and the second tooth,
the web to prevent engagement of the first tooth of the rack between the first tooth and the second tooth of the pinion.

2. The gear arrangement of claim 1, further comprising:
the pinion having a third tooth adjacent the second tooth,
the first tooth of the rack to engage the pinion between the second tooth and the third tooth of the pinion.

3. The gear arrangement of claim 2, further comprising:
the pinion having a fourth tooth adjacent the third tooth and an additional web between the third tooth and the fourth tooth,
the additional web of the pinion to permit engagement of the second tooth of the rack between the third tooth and the fourth tooth of the pinion.

4. The gear arrangement of claim 1, wherein the web is provided at a side of the first tooth and the second tooth of the pinion.

5. The gear arrangement of claim 1, wherein the web reduces a face width of opposing faces of the first tooth and the second tooth of the pinion.

6. A gear arrangement for a printer, comprising:
a rack including a series of teeth, the series of teeth including at least an initial tooth and a next tooth, a width of the initial tooth being greater than a width of the next tooth; and
a pinion including a web between alternating pairs of adjacent teeth,
the web to block engagement of the initial tooth of the rack between a respective pair of the alternating pairs of adjacent teeth of the pinion having the web therebetween.

7. The gear arrangement of claim 6, further comprising:
the initial tooth of the rack to engage the pinion between one tooth of a first pair of the alternating pairs of adjacent teeth of the pinion having the web therebetween and one tooth of a second pair of the alternating pairs of adjacent teeth of the pinion having the web therebetween.

8. The gear arrangement of claim 6, further comprising:
the web to allow engagement of the next tooth of the rack between a respective pair of the alternating pairs of adjacent teeth of the pinion having the web therebetween.

9. The gear arrangement of claim 6, wherein the web between alternating pairs of adjacent teeth is provided at an end of a width of the teeth of the pinion.

10. The gear arrangement of claim 6, wherein the web between alternating pairs of adjacent teeth reduces a face width of opposing faces of a respective pair of the alternating pairs of adjacent teeth of the pinion having the web therebetween.

11. A method of gear engagement in a printer, comprising:
engaging a rack with a pinion, the rack having an initial tooth at one end and a next tooth adjacent the initial tooth, a width of the initial tooth being greater than a width of the next tooth, the pinion having a web between alternating pairs of adjacent teeth,
engaging the rack with the pinion including preventing, by the web, engagement of the initial tooth of the rack between a respective pair of the alternating pairs of adjacent teeth of the pinion having the web therebetween.

12. The method of claim 11, further comprising:
engaging the rack with the pinion further including permitting engagement of the initial tooth of the rack between one tooth of a first pair of the alternating pairs of adjacent teeth of the pinion having the web therebetween and one tooth of a second pair of the alternating pairs of adjacent teeth of the pinion having the web therebetween.

13. The method of claim 11, further comprising:
engaging the rack with the pinion further including permitting, by the web, engagement of the next tooth of the rack between a respective pair of the alternating pairs of adjacent teeth of the pinion having the web therebetween.

14. The method of claim 11, wherein the web between alternating pairs of adjacent teeth is provided at an end of a width of the teeth of the pinion.

15. The method of claim 11, wherein the web between alternating pairs of adjacent teeth reduces a face width of opposing faces of a respective pair of the alternating pairs of adjacent teeth of the pinion having the web therebetween.
